(19) United States
(12) Patent Application Publication
(10) Pub. No.: US 2025/0161929 A1
(43) Pub. Date: May 22, 2025

(54) FLUID PROVISION MODULE

(71) Applicant: CLICKBIO, INC., Reno, NV (US)

(72) Inventors: Quinn Curtis James Wilson CHAPMAN, Reno, NV (US); Justin FERRANTO, Reno, NV (US)

(73) Assignee: CLICKBIO, INC., Reno, NV (US)

(21) Appl. No.: 18/730,549

(22) PCT Filed: Feb. 3, 2023
(86) PCT No.: PCT/US2023/061964

§ 371 Date: Jul. 19, 2024

Related U.S. Application Data
(60) Provisional application No. 63/306,591, filed on Feb. 4, 2022.

(51) Int. Cl. B01L 3/02

(52) U.S. Cl. CPC B01L 3/0213; B01L 2200/027; B01L 2200/0605; B01L 2300/0663; B01L 2400/0487

(57) ABSTRACT

Described herein are various fluid provision systems that may be used in a laboratory setting. The fluid provision systems minimize waste of pipetted liquid sample or reagents and may be used, e.g., in combination with a multi-well plate such as in NGS processes. Other systems include those configured for compatibility with centrifuge rotors or multichannel pipettes with 12 or more channels.

### CROSS-REFERENCE TO RELATED APPLICATIONS

This application claims the benefit of U.S. Provisional Application No. 63/306,591, filed Feb. 4, 2022, the entire contents of which are fully incorporated herein by reference.

### BACKGROUND

The ability to efficiently pipette liquids can become a limiting factor in virtually any chemistry or life sciences laboratory. Whether due to the limited availability of precious samples that have taken weeks (or months) to produce, or the use of expensive reagents—such as enzymes, antibodies and probes—there is a real cost to every microliter wasted. The value of samples or reagents needs to be balanced against productivity and throughput, because using a single channel pipette capable of accessing the last few microliters of a reagent or sample is a laborious and time-consuming process. Multichannel pipettes allow faster and more reproducible assay setup, but must be used in combination with reagent reservoirs such that the tips of all of the individual pipettes simultaneously draws from the reagent reservoir. This can be a drawback, because the high dead volumes of conventional reservoirs increase the cost of experiments.

Next generation sequencing (NGS) is one example where the high cost of NGS reagents demands low waste. In addition, the time required to precisely perform all of the necessary low volume pipetting steps adds to the cost of analysis. Multichannel electronic pipettes have the potential to significantly reduce the time required for library preparation in microplates or tube racks, but conventional reagent reservoirs tend to be very wasteful due to their large dead volumes. There is a need to provide commercially-available low-cost low-waste solutions to improve laboratory workflow and to decrease waste of precious reagent or sample.

The present disclosure provides a variety of solutions to the aforementioned challenges as well as compatibility with many of the tools used in NGS, thereby simplifying workflow.

### SUMMARY

Provided herein are various liquid reservoirs that may be used, e.g., in a laboratory setting to minimize loss of a reagent, sample, or other liquid. In any embodiment, a liquid reservoir comprises a walled perimeter formed of at least one wall segment and a bottom segment, defining a liquid space where liquid may be contained. In various embodiments, the liquid reservoir may be sized to receive and/or connect to a multi-well plate.

In some embodiments, the fluid reservoir is for minimizing loss of a liquid, said reservoir comprising: a walled perimeter formed of at least one wall segment, the walled perimeter having a top edge and a bottom edge, and a floor portion joined to the walled perimeter, thereby forming a liquid space configured to hold at least one volume of liquid, the floor portion containing at least one indentation and having a lowest point, wherein the at least one indentation is provided in the lowest point of the floor portion.

In some embodiments, the walled perimeter of the reservoir comprises a first wall segment, a second wall segment, a third wall segment, and a fourth wall segment, wherein the first and third wall segments are parallel to each other and the second and fourth wall segments are parallel to each other.

In some embodiments, the walled perimeter is rectangular-shaped.

In some embodiments, the reservoir may further comprise a projection on each of the first and third wall segments, the projection extending into the liquid space and positioned on the first and third wall segments at a nesting distance below the top edge of the walled perimeter.

In some embodiments, the reservoir may further comprise a projection on each of the second and fourth wall segments, the projection extending into the liquid space and positioned on the second and fourth wall segments at the nesting distance below the top edge of the walled perimeter.

In some embodiments, the reservoir may have a nesting distance is about 2 mm to about 2.5 mm.

In some embodiments, the reservoir may be such that first wall segment and third wall segments each have an inside length of about and wherein the second wall segment and fourth wall segments each have an inside length of about 126.2 mm to about 127.3 mm and an inside width of about 83.9 mm to about 85 mm.

In some embodiments, the reservoir may be such that each of the first wall segment, second wall segment, third wall segment, and fourth wall segment have a surface that face the liquid space and wherein the floor portion has at least one bottom surface facing the liquid space, wherein the four wall segment surfaces and the at least one bottom surface is resistant to one or more of the binding of protein, peptides, nucleotides, or nucleic acids.

In some embodiments, the walled perimeter and the floor portion of the reservoir may comprise a polymer.

In some embodiments, the floor portion of the reservoir may comprise one or more inverted cones or pyramids.

In some embodiments, the floor portion of the reservoir comprises a rectangular pyramid.

In some embodiments, the floor portion of the reservoir comprises an equilateral pyramid.

In some embodiments, the first wall segment, second wall segment, third wall segment, and fourth wall segment has a thickness of about 0.55 mm to about 0.60 mm.

In some embodiments, the top edge is rectangular-shaped.

In some embodiments, the bottom edge is a rounded rectangle having four rounded corners.

In some embodiments, each of the four rounded corners bas a corner radius of about 1 mm to about 15 mm.

In some embodiments, there is provided a reservoir for minimizing loss of a liquid, the reservoir comprising: a walled perimeter formed of at least one wall segment, the walled perimeter having a top edge and a bottom edge, and a floor portion joined to the walled perimeter, thereby forming a liquid space configured to hold at least one volume of liquid, wherein the reservoir has a length dimension and a width dimension, the floor portion contains at least one trough indentation spanning the length dimension and has a substantially two dimensional bottom, and the two dimensional bottom is provided in the lowest point of the floor portion.

In some embodiments, the bottom edge is a rounded rectangle having four rounded corners.

In some embodiments, the walled perimeter comprises a first wall segment, a second wall segment, a third wall segment, and a fourth wall segment, wherein the first and third wall segments are parallel to each other and the second and fourth wall segments are parallel to each other.

In some embodiments, the walled perimeter is rectangular-shaped.

In some embodiments, the reservoir further comprises a projection on each of the first and third wall segments, the projection extending into the liquid space and positioned on the first and third wall segment at a distance below the top edge of the walled perimeter.

In some embodiments, the reservoir further comprises a projection on each of the second and fourth wall segments, the projection extending into the liquid space and positioned on the second and fourth wall segment at a nesting distance below the top edge of the walled perimeter.

In some embodiments, the nesting distance of the reservoir is about 2 mm to about 2.5 mm.

In some embodiments, the first and third wall segment each have an inside length of about and wherein the second and fourth wall segments each have an inside length of about 126.2 mm to about 127.3 mm and an inside width of about 83.9 mm to about 85 mm.

In some embodiments, each of the first wall segment, second wall segment, third wall segment, and fourth wall segment have a surface that face the liquid space and wherein the floor portion has at least one bottom surface facing the liquid space, wherein the four wall segment surfaces and the at least one bottom surface is resistant to binding with one or more of protein, peptides, nucleotides, or nucleic acids.

In some embodiments, the reservoir may be used with a fluid provision module, which comprises a fluid delivery tube, a fluid drain tube, a pump, and a sensor.

In some embodiments, the reservoir may be used with a microcontroller (e.g., Arduino™), a motor controller (e.g., a PWM motor speed controller), and/or input/output (I/O) device hardware, such as a keypad and a screen (e.g., an LCD screen).

In some embodiments, the fluid provision module may be attached to the reservoir, through clipping, fastening, or other attachment methods.

In some embodiments, the fluid delivery tube and the fluid drain tube of the fluid provision module are adjustable in the X and Y directions to accommodate single-channel or multichannel pipettes of varying sizes.

In some embodiments, the pump is a positive displacement pump, a centrifugal pump, or an axial-flow pump.

In some embodiments, the pump is a peristaltic pump.

In some embodiments, the pump is controlled by the sensor.

In some embodiments, the pump is controlled by a timer.

In some embodiments, the pump is controlled by a combination of the sensor and a timer.

In some embodiments, the pump is controlled by a microcontroller, and/or by an external liquid handling robot.

In some embodiments, the pump does not contact the fluid.

In some embodiments, the sensor to determine fluid level may be an optical sensor, a vibrating sensor, an ultrasonic sensor, a capacitance sensor, a radar sensor, or a conductivity sensor.

In some embodiments, the sensor is a capacitance sensor.

In some embodiments, the fill and drain speeds are adjustable.

In some embodiments, the fluid provision module is used for collecting and preserving valuable fluids. In some embodiments, the fluid provision module comprises a fluid supply tube for providing fluid, a fluid drain tube for removing fluid, a pump for pumping fluid, and a sensor for sensing fluid level.

In some embodiments, the fluid supply tube and the fluid drain tube are adjustable, such that they may be positioned in differing configurations depending on the needs of a user of said module. For example, the fluid supply tube and the fluid drain tube may be positioned to accommodate either a single-channel pipette or a multichannel pipette with minimal loss of fluid.

In some embodiments, the sensor is used sense fluid level. The module may be designed such that, if the sensor detects that the fluid level is above a certain point, the pump shuts off and fluid ceases to be pumped through the fluid supply tube. The module may be designed such that, if the sensor detects that the fluid level is below a certain point, the pump turns on and fluid is pumped through the fluid supply tube.

In some embodiments, the fluid drain tube may be used as an overflow prevention mechanism, so that in the case of imminent overflow, the fluid will instead flow through the fluid drain tube to be collected in a designated collection vessel. For example, if the sensor fails and the module continues filling beyond the specified point, the fluid drain tube allows the fluid to be collected safely without risk of overflow and subsequent loss of fluid.

In some embodiments, the module comprises components that may be disposed or sterilized.

In some embodiments, the module may be configured such that it functions as a fluid waste station.

In some embodiments, the module may be configured such that it functions as a continuously recirculating fill station.

In some embodiments, the fluid provision module may be used in combination with the reservoir. The fluid provision module may be attached to the side of the reservoir, through clipping, fastening, or other attachment methods, such that the fluid provision module may be used with the reservoir.

In some embodiments, where the fluid provision module and reservoir are used together as a system, the system may be designed such that the sensor senses the fluid level within reservoir. The system may be configured such that, if the sensor detects that the fluid level in the reservoir is below a certain point, the pump is turned on and fluid is pumped through the fluid supply tube into the reservoir. The system may be designed such that, if the sensor detects that the fluid level is above a certain point, the pump shuts off and fluid ceases to be pumped through the fluid supply tube into the reservoir.

In some embodiments, the fluid drain tube may be used as an overflow prevention mechanism, so that in the case of imminent overflow of the reservoir, the fluid will instead flow through the fluid drain tube to be collected in a designated collection vessel. For example, if the sensor fails and the module continues filling beyond the specified point, the fluid drain tube allows the fluid to be collected safely without risk of overflow and subsequent loss of fluid from the reservoir.

In some embodiments, the module and reservoir system may be configured such that it functions as a fluid waste station.

In some embodiments, the module and reservoir system may be configured such that it functions as a continuously recirculating fill station.

In some embodiments, the module and reservoir system may be used with a fluid-handling robot.

### DRAWINGS

The foregoing and other features of the disclosure will become more apparent from the following detailed description of several embodiments, which proceeds with reference to the accompanying figures.

FIG. 1 depicts an isometric view of one embodiment of a liquid reservoir as described herein comprising a single low point in the reservoir.

FIG. 2 depicts a lateral cross-section profile of the embodiments in FIGS. 1 and 2 of a liquid reservoir as described herein comprising a single low point in the reservoir.

FIG. 3 depicts a longitudinal cross-sectional profile of the embodiments in FIGS. 1 and 2 of a liquid reservoir as described herein comprising a single low point in the reservoir.

FIG. 4 depicts a bottom view of the embodiment in FIG. 1 of a liquid reservoir as described herein comprising a single low point in the reservoir.

FIG. 5 depicts an isometric view of one embodiment of a liquid reservoir as described herein comprising a longitudinal trough.

FIG. 6 depicts a lateral cross-section profile of the embodiments in FIGS. 5 and 6 of a liquid reservoir as described herein comprising a longitudinal trough

FIG. 7 depicts a longitudinal cross-sectional profile of the embodiments in FIGS. 5 and 6 of a liquid reservoir as described herein comprising a longitudinal trough.

FIG. 8 depicts a bottom view of the embodiment in FIG. 5 of a liquid reservoir as described herein comprising a longitudinal trough.

FIG. 9 depicts an isometric view of one embodiment of a liquid reservoir as described herein comprising a lateral trough and rounded bottom corners.

FIG. 10 depicts a bottom view of the embodiment in FIG. 9 of a liquid reservoir as described herein comprising a lateral trough and rounded bottom corners.

FIG. 11 depicts an isometric of one embodiment of a liquid reservoir as described herein comprising a single low point in the liquid reservoir and rounded bottom corners.

FIG. 12 depicts a bottom view of the embodiment in FIG. 11 of a liquid reservoir as described herein comprising a single low point in the liquid reservoir and rounded bottom corners.

FIG. 13 depicts a representative side view of any one of the embodiments pictured in FIGS. 1-12 identifying various fill line demarcations.

FIG. 14A depicts a standard 96-well plate that is compatible with any liquid reservoir as described herein, and

FIG. 14B depicts a side profile view of a well plate depicting various dimensions that may be considered when designing a liquid reservoir as described herein.

FIG. 15A depicts an angled front view of the fluid provision module.

FIG. 15B depicts an angled side view of the fluid provision module.

FIG. 15C depicts an angled rear view of the fluid provision module.

FIG. 16A depicts the top view of the fluid provision module.

FIG. 16B depicts the front view of the fluid provision module.

FIG. 16C depicts the side view of the fluid provision module.

FIG. 16D depicts the rear view of the fluid provision module.

FIG. 17A depicts the top view of the fluid provision module combined with the reservoir.

FIG. 17B depicts an angled side view of the fluid provision module combined with the reservoir.

FIG. 17C depicts an angled rear view of the fluid provision module combined with the reservoir.

FIG. 17D depicts the front view of the fluid provision module combined with the reservoir.

FIG. 17E depicts the side view of the fluid provision module combined with the reservoir.

FIG. 17F depicts the rear view of the fluid provision module combined with the reservoir.

FIG. 18 is an exploded view of the fluid provision module and reservoir system, showing the main components.

FIGS. 19A and 19B depict angled views of an exemplary pump that is part of the fluid provision module.

FIG. 20A depicts the top view of the pump in FIGS. 19A and 19B.

FIG. 20B depicts the front view of the pump in FIGS. 19A and 19B.

FIG. 20C depicts the side view of the pump in FIGS. 19A and 19B.

FIG. 20D depicts the rear view of the pump in FIGS. 19A and 19B.

FIG. 21 is an exploded view of the pump in FIGS. 19A and 19B and its main components.

FIG. 22 depicts an angled view of another exemplary pump that is part of the fluid provision module.

FIG. 23A depicts a top view of the pump in FIG. 22.

FIG. 23B depicts a front view of the pump in FIG. 22.

FIG. 23C depicts a side view of the pump in FIG. 22.

FIG. 24 is an exploded view of the pump in FIG. 22 and its main components.

### DETAILED DESCRIPTION

The present disclosure provides various liquid reservoirs for minimizing loss of a liquid and/or for use with large multi-channel pipettes, such as those having 12 or more channels. In general, the liquid reservoirs comprise a walled perimeter and a floor portion attached thereto, defining an interior space therein for containing a liquid. The liquid may be a reagent, a sample, or any other liquid used in a laboratory setting. The liquid reservoirs comprise various beneficial design characteristics which will now be described with respect to example embodiments below.

### Single Low Point Reservoir

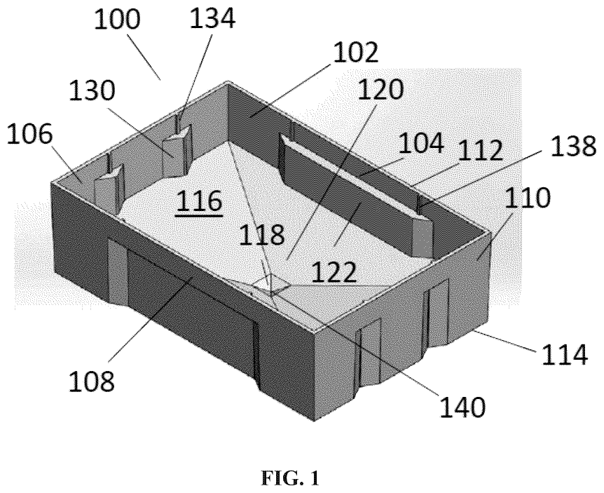

In one embodiment, the present disclosure provides a liquid reservoir comprising a single low point where liquid may pool for maximal recovery of the liquid. As such, a liquid reservoir will generally have a walled perimeter comprising at least one wall segment attached to a floor portion, thereby defining liquid space. The liquid reservoir comprising the single low point (herein “single low point reservoir”) may be substantially rigid in structure and be sized for compatibility with systems typically used in combination with a liquid reservoir, such as a well plate (e.g., 96 well micro-plate, polymerase chain reaction (PCR) plate). As used herein, “well plate” and “microplate” are used interchangeably and refer to a plate with a plurality of wells that can hold a volume of liquid and are arranged in a regular (e.g., rectangular) pattern. Well plates are available in many shapes and sizes, depending on any given laboratory application. FIG. 1 shows one embodiment of a single low point reservoir 100 which comprises a walled perimeter 102 formed of wall segments 104, 106, 108, 110, the walled perimeter having a top edge 112, a bottom edge 114, and a floor portion 116 joined to the walled perimeter 102 to form a liquid space 120 configured to hold a volume of liquid. The floor portion 116 has at least one indentation 118 with a lowest point 140 provided therein. The first wall segment 104, second wall segment, 106, third wall segment, 108, and fourth wall segment 110 define a generally rectangular walled perimeter 102 wherein the first wall segment 104 and third wall segment 108 are parallel and the second wall segment 106 and fourth wall segment 110 are parallel.

On each of the first wall segment 104 and third wall segment 108, there is a longitudinal support projection 122 extending into the liquid space 120. On each of the first wall segment 104 and third wall segment 108, there are two longitudinal securing projections 138 located above the longitudinal support projection 122 and extending to the top edge 114 of the walled perimeter 102. As used herein, “longitudinal” is used to refer to the largest dimension of the liquid reservoir. As used herein, “lateral” is used to refer to refer to the direction orthogonal to the longitudinal direction and parallel to a plane formed by the intersection of the floor portion 116 with each wall segment 104, 106, 108, 110.

The second wall segment 106 and fourth wall segment 110 each comprise at least one lateral support projection 130. On each of the second wall segment 106 and fourth wall segment 110, there are two lateral securing projections 134 located above the lateral support projection 130 and extending to the top edge 114 of the walled perimeter 102. Longitudinal and lateral securing projections (134, 138) are optional, but may be included to prevent plate movement during centrifugation and/or to hold an inverted microplate more securely. The embodiment depicted in FIG. 1 comprises two securing projections on each wall segment, however, any number of securing projections may be used, such as 0 (absent), 1, 2, 3, 4, or more, on each side. In any embodiment, some wall segments may include one or more securing projections while other wall segments are absent securing projections.

Additionally, the number of longitudinal and lateral support projections 122, 130 are not particularly limited to one on each wall segment, as depicted in FIG. 1. Each wall segment may comprise, e.g., 0, 1, 2, 3 or more support projections on each wall segment. Further, one or more support projections may be present on only one pair of parallel wall segments (e.g., first and third or second and fourth) while the other pair of parallel wall segments are absent support projections. Additionally, the number of supporting projections may be different on each wall segment. The shape of the longitudinal and lateral supporting projections 122, 130 in FIG. 1 are such that each wall segment indents inwards towards the liquid space 120 to form a void or cavity in the wall with respect to the walled perimeter. However, in any embodiment described herein, including those described below, an indentation may not form the projection, but rather the projection may be formed as a separate element attached to the wall segment.

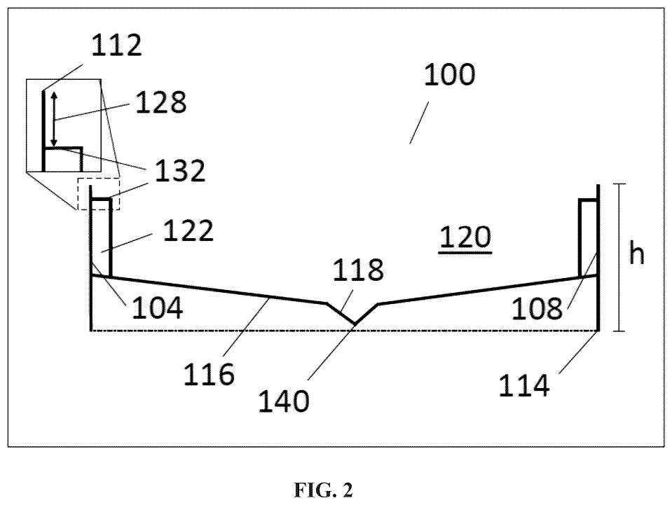

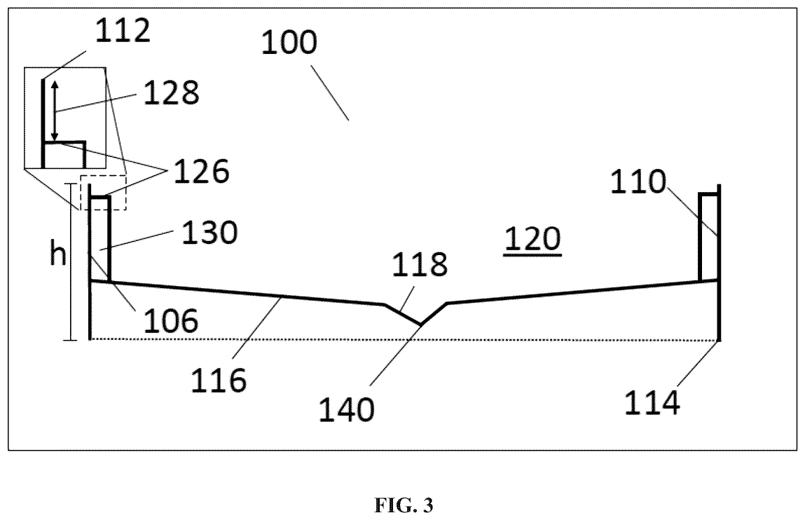

FIG. 2, where like numbers represent like elements, depicts a lateral cross section that passes through the single low point 140 of the single low point reservoir 100. The at least one longitudinal support projection 122 comprises a top surface 132 positioned at a nesting distance 128 below the top edge 114 of the walled perimeter 102. FIG. 3, where like numbers represent like elements, depicts a longitudinal cross section that passes through the single low point 140 of the single low point reservoir 100. The at least one lateral support projection 130 comprises a top surface 126 positioned at the nesting distance 128 below the top edge 114 of the walled perimeter 102. Nesting distance, as used herein, is the distance between the top of a supporting projection and the top edge of the reservoir and may be utilized, e.g., to support an inverted microplate that is nested in the top edge of the liquid reservoir.

While indentation 118 and lowest point 140 are depicted in FIGS. 2 and 3 as located substantially in the center of the floor portion 116, the indentation comprising the lowest point may be any location at any point in the floor portion 116. Furthermore, the floor portion can include one or more inverted cones or pyramids.

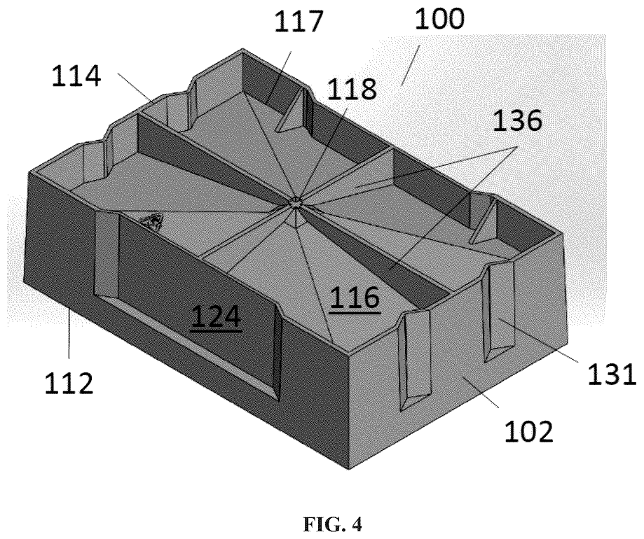

A bottom view of the single low point reservoir 100 shown in FIG. 1 is provided in FIG. 4, where like numbers represent identical elements. Indentations 124, 131 corresponding to the longitudinal support projections 122 and lateral support projections 130 (from FIGS. 1-3) can be seen. The floor portion 116 connects to the walled perimeter 102 at a location 117 between the top edge 112 and the bottom edge 114. The floor portion 116 is shaped to provide the lowest point 118, which is structurally stabilized within the void surrounding it with support structures 136. While four support structures 136 are shown in FIG. 4, any number of support structures 136 may be used, such as 2, 3, 5, 6, 7, or 8. The support structures 136 provide mechanical strength to the overall reservoir structure. In any embodiment, however, the void formed between the floor portion 116 and the bottom edge 114 of the walled perimeter 102 need not be void and could instead be solid or partially solid (e.g., partially filled or comprise additional support structures).

In any embodiment, the indentation 118 may be shaped substantially as shown in FIG. 1, where the lowest point 140 is at the apex of an inverted pyramid having four faces. In any embodiment, such an inverted pyramid may have three faces or more than four faces, such as 5, 6, 7, or 8 faces. Alternatively, and in any embodiment, the inverted pyramid may be partially or fully conical. The intersection of the indentation 118 with the floor portion 116 may be angular, as shown in FIG. 1 or may substantially curved to avoid an edge at the junction thereof. FIG. 1 depicts an inverted pyramid indentation 118 that is nested within the floor portion 116. In any embodiment, there may be two or more successively nesting indentations, such an inverted pyramid nested within a larger inverted pyramid, nested within the floor portion 116.

### Longitudinal Trough Liquid Reservoir

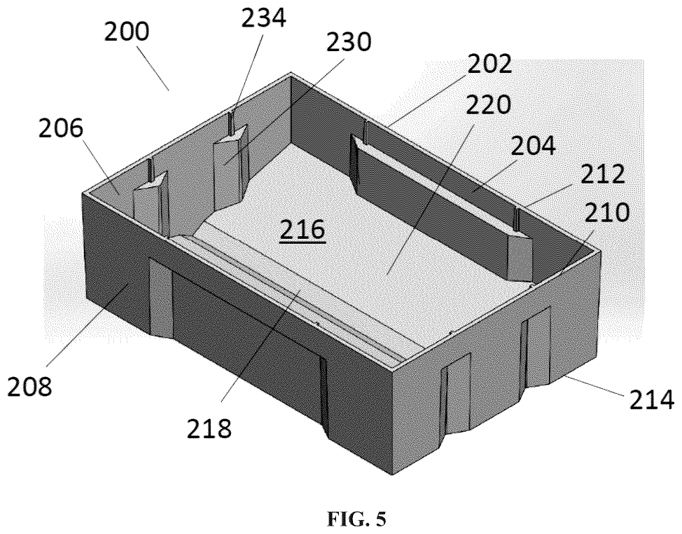

In another embodiment, the present disclosure provides a liquid reservoir for minimizing loss of a liquid while also providing compatibility with a larger multi-channel pipette, e.g., a multi-channel pipette having at least twelve (12) channels. The liquid reservoir is capable of holding a volume of liquid and comprises a trough spanning a longitudinal axis of the reservoir for pooling of a liquid. Such a liquid reservoir will generally have a walled perimeter comprising at least one wall segment and a floor portion attached thereto, defining liquid space. A liquid reservoir comprising a longitudinal trough (herein “longitudinal trough reservoir”) may be substantially rigid in structure and be sized for compatibility with systems typically used in combination with a liquid reservoir, such as a microplate (e.g., a 96 well plate or a PCR plate). FIG. 5 shows one embodiment of a longitudinal trough reservoir 200 which comprises a walled perimeter 202 formed of wall segments 204, 206, 208, 210, the walled perimeter having a top edge 212 and a bottom edge 214 and a floor portion 216 joined to the walled perimeter 202 to form a liquid space 220 configured to hold a volume of liquid. The floor portion 216 has at least one longitudinal trough indentation 218 that spans a length of the longitudinal trough reservoir 200 with a substantially two-dimensional bottom 240 to minimize liquid loss therein.

In any embodiment, the trough indentation may be shaped substantially as shown in FIG. 5, having where the lowest point 240 is at the apex of an inverted triangular cross-section. The intersection of the indentation 218 with the floor portion 216 may be angular, as shown in FIG. 5 or may substantially curved to avoid an edge at the junction thereof.

Longitudinal trough reservoir 200 comprises two lateral support projections 230 on each of the second wall segment 206 and fourth wall segment 210 and two lateral securing projections 234 located above the lateral support projection 230 and extending to the top edge 214 of the walled perimeter 202. Longitudinal trough reservoir 200 comprises two longitudinal support projections 222 on each of the first wall segment 204 and third wall segment 208 and two longitudinal securing projections 238 located above the longitudinal support projection 222 and extending to the top edge 214 of the walled perimeter 202. Again, the securing projections (234, 238) are optional, but serve to prevent plate movement during centrifugation and hold an inverted well or PCR plate more securely. The embodiment depicted in FIG. 5 comprises two securing projections on each wall segment, however, any number of securing projections may be used, such as 0 (absent), 1, 2, 3, 4, or more, on each side. In any embodiment, some wall segments may include one or more securing projections while other wall segments are absent securing projections.

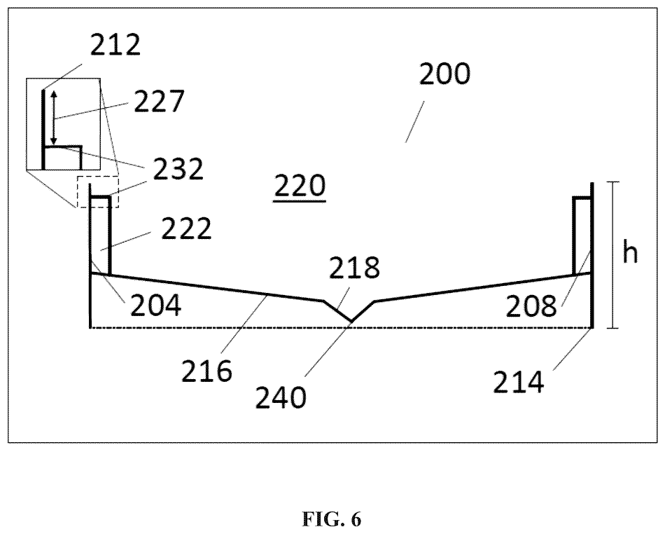

In FIG. 6 (where like numbers represent like elements), which depicts the centermost lateral cross-sectional view of the longitudinal trough reservoir 200, the at least one longitudinal support projection 222 has a top surface 225 positioned at a nesting distance 228 below the top edge 214 of the walled perimeter 202. The lateral cross section of the at least one trough indentation 218 has a low point 240, which forms the bottom of the at least one trough indentation 218.

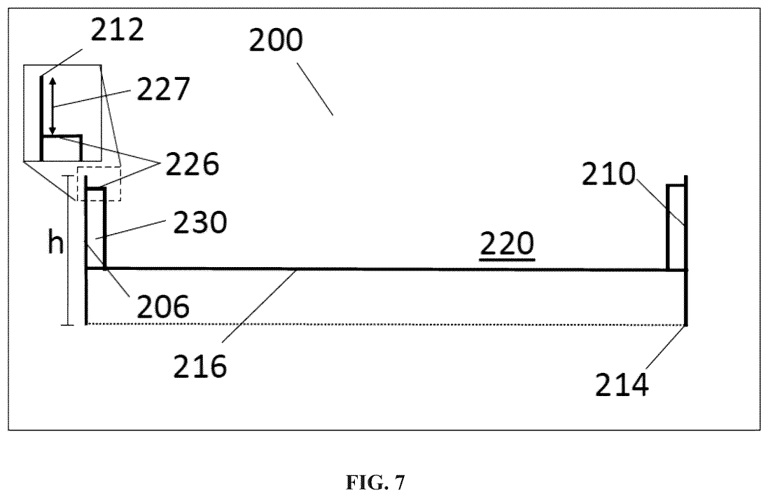

In FIG. 7 (where like numbers represent like elements), which depicts the centermost longitudinal cross section of the longitudinal trough reservoir 200, the at least one lateral support projection 230 comprises a top surface 232 positioned at the nesting distance 228 below the top edge 214 of the walled perimeter 202.

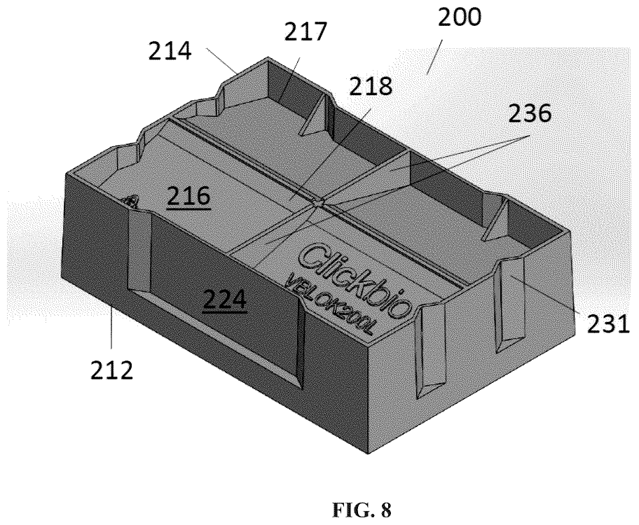

A bottom view of the longitudinal reservoir 200 shown in FIG. S is provided in FIG. 8, where like numbers represent identical elements. Indentations 224, 231 corresponding to the longitudinal support projections 222 and lateral support projections 230 can be seen. The floor portion 216 connects to the walled perimeter 202 at a location between the top edge 212 and the bottom edge 214 and the floor portion 216 is shaped to provide a trough indentation 218 which is structurally secured with two support structures 236. The support structures 236 provide mechanical strength to the overall reservoir structure.

### Rounded Bottom Edge

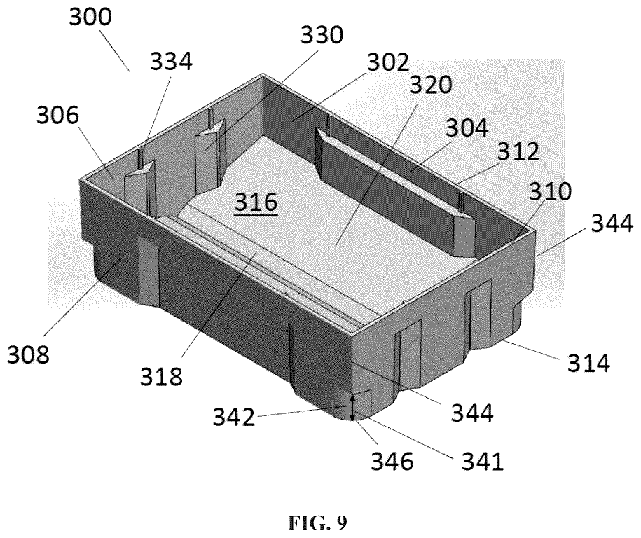

In any embodiment, the bottom edge, being substantially rectangular in each of FIGS. 1-8, may have rounded corners as shown in FIG. 9. Advantageously, these rounded corners may provide compatibility with various common laboratory instruments such as a centrifuge or rotor compatible with deep well plates (which are typically about 40 mm to about 45 mm tall), such as the Eppendorf™ Rotor for Benchtop Centrifuge or Aerosol-tight deepwell plate Rotor A-2-DWP-AT1, sold by Fisher Scientific, which can be used with Eppendorf™ centrifuges.

FIG. 9 depicts a longitudinal trough rounded bottom reservoir 300 with a longitudinal trough indentation 318 similar to that shown in FIGS. 5-8 and comprising two longitudinal support projections 322 on each of the first wall segment 304 and third wall segment 308 and two longitudinal securing projections 338 located above the longitudinal support projection 322 and extending to the top edge 314 of the walled perimeter 302. Longitudinal trough rounded bottom reservoir 300 comprises two lateral support projections 330 on each of a second wall segment 306 and fourth wall segment 310 and two lateral securing projections 334 located above the lateral support projection 330 and extending to the top edge 314 of the walled perimeter 302. A rounded plane 342 carved each corner 344 of the walled perimeter 302 defines rounded bottom corners 346. The rounded plane has a length 341 and is defined by a radius of curvature and an arc length (not shown in FIG. 9). Again, the securing projections (334, 338) are optional, but serve to prevent plate movement during centrifugation and hold an inverted well or PCR plate more securely. The embodiment depicted in FIG. 9 comprises two securing projections on each wall segment, however, any number of securing projections may be used, such as 0 (absent), 1, 2, 3, 4, or more, on each side. In any embodiment, some wall segments may include one or more securing projections while other wall segments are absent securing projections.

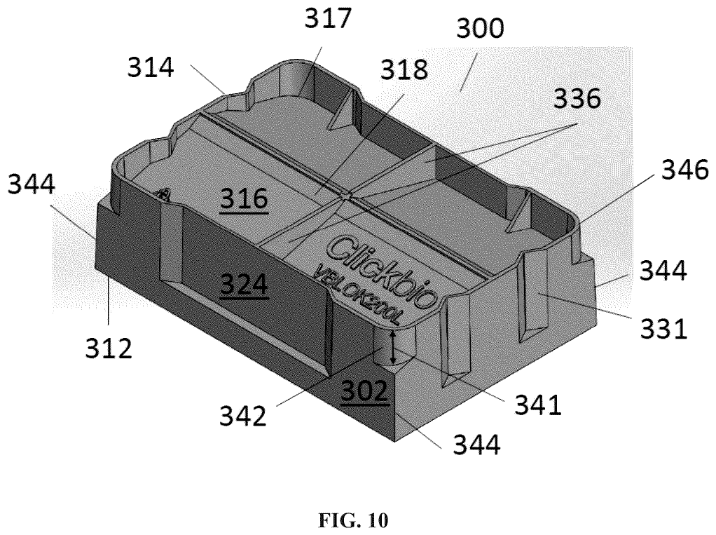

A bottom view of the longitudinal trough rounded bottom reservoir 300 shown in FIG. 9 is provided in FIG. 10, where like numbers represent identical elements as described in FIG. 9. Indentations 324, 331 corresponding to the longitudinal support projections 322 and lateral support projections 330 can be seen. The floor portion 316 connects to the walled perimeter 302 at a location between the top edge 312 and the bottom edge 314 and the floor portion 316 is shaped to provide a trough indentation 318 which is structurally secured with two support structures 336. The support structures 336 provide mechanical strength to the overall reservoir structure but reduce the amount of construction material required (for example, the void area between the floor portion 316 and the bottom edge 314 of the walled perimeter 302 could be solid).

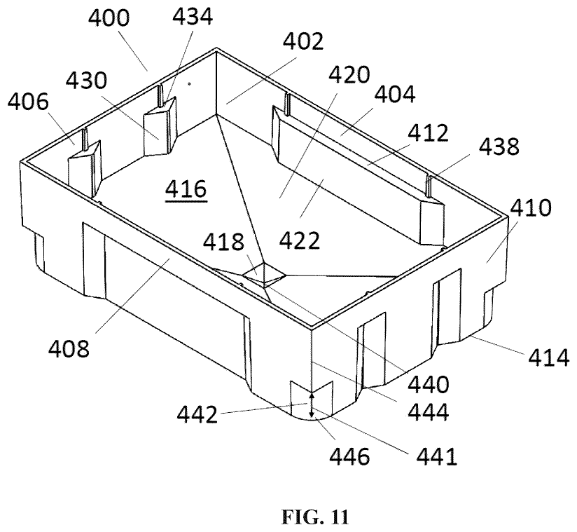

While FIG. 9 depicts a longitudinal trough reservoir with a rounded bottom reservoir, a single low point reservoir may also have a rounded bottom, such as shown in FIG. 11. FIG. 11 depicts a single low point reservoir 400 which comprises a walled perimeter 402 formed of wall segments 404, 406, 408, 410, the walled perimeter having a top edge 412 and a bottom edge 414 and a floor portion 416 joined to the walled perimeter 402 to form a liquid space 420 configured to hold a volume of liquid. The floor portion 416 has at least one indentation 418 with a lowest point 440 contained therein. The first wall segment 404, second wall segment, 406, third wall segment, 408, and fourth wall segment 410 define the generally rectangular walled perimeter 402 wherein the first wall segment 404 and third wall segment 408 are parallel and the second wall segment 406 and fourth wall segment 410 are parallel.

On each of the first wall segment 404 and third wall segment 408, there is a longitudinal support projection 422 extending into the liquid space 420. On each of the first wall segment 404 and third wall segment 408, there are two longitudinal securing projections 438 located above the longitudinal support projection 422 and extending to the top edge 414 of the walled perimeter 402.

The second wall segment 406 and fourth wall segment 410 each comprise at least one lateral support projection 430. On each of the second wall segment 406 and fourth wall segment 410, there are two lateral securing projections 434 located above the lateral support projection 430 and extending to the top edge 414 of the walled perimeter 402. Again, the securing projections (434, 438) are optional, but serve to prevent plate movement during centrifugation and hold an inverted well or PCR plate more securely. The embodiment depicted in FIG. 11 comprises two securing projections on each wall segment, however any number of securing projections may be used, such as 0 (absent), 1, 2, 3, 4, or more, on each side. In any embodiment, some wall segments may include one or more securing projections while other wall segments are absent securing projections.

A rounded plane 442 carved into each bottom corner 444 of the walled perimeter 402 defines rounded bottom comers 446. The rounded plane has a length 441 and is defined by a radius of curvature and an arc length (not shown in FIG. 11).

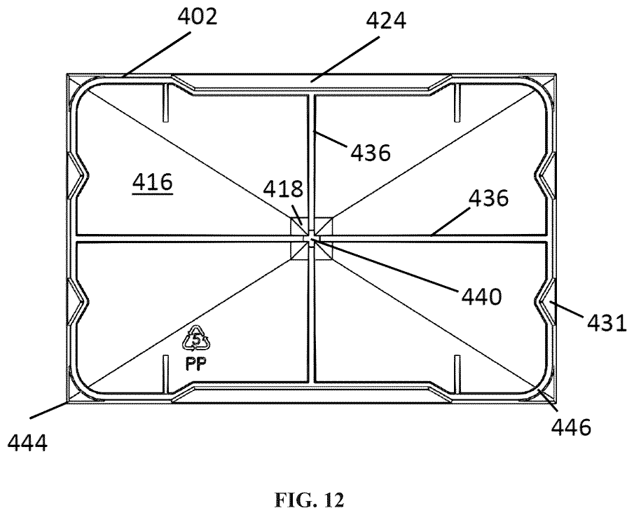

A bottom view of the single low point rounded bottom reservoir 400 shown in FIG. 11 is provided in FIG. 12, where like numbers represent identical elements as described in FIG. 11. Indentations 424, 431 corresponding to the longitudinal support projections and lateral support projections, respectively can be seen. The floor portion 416 connects to the walled perimeter 402 at a location between the top edge and the bottom edge. The floor portion 416 is shaped to provide an indentation 418 which is structurally secured with support structures 436. The support structures 436 provide mechanical strength to the overall reservoir structure.

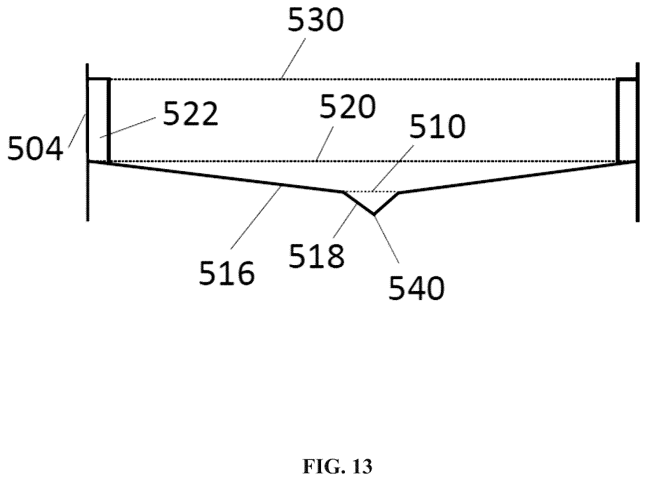

FIG. 13 depicts a general cross-section of many of the embodiments disclosed herein, having an indentation 518 in a floor portion 516 with a low point 540 (representing either a single low point or the lowest indentation of a trough). The size of the various elements shown, such as the projections 522 and the size of the indentation 518 may be described by various fill lines, represented by dotted lines in FIG. 13. Fill line 1 510, corresponding to the top of the indentation 518 may be a first distance above the low point 540. Fill line 2 520, corresponding to where the wall 504 and the floor portion 516 meet, may be a second distance above the low point 540. Fill line 3 530, corresponding to the top surface of the supporting projection 522 may be a third distance above the low point 530. For example, in any embodiment, the first distance may be about 2.5 mm to about 3 mm, such as about 2.92 mm. In any embodiment, the second distance may be about 12 mm to about 15 mm, such as about 14 mm. In any embodiment, the third distance may be about 25 mm to about 30 mm, such as about 28 mm.

The size of the various elements shown, such as the projections 522 and the size of the indentation 518 may additionally or alternatively be described by various fill lines corresponding to volumes of fluid that are contained within the reservoir. Fill line 1 510, corresponding to the top of the indentation 518 may correspond to a first volume. Fill line 2 520, corresponding to where the wall 504 and the floor portion 516 meet, may correspond to a second volume. Fill line 3 530, corresponding to the top surface of the supporting projection 522 may correspond to a third volume. For example, in any embodiment, the first volume may be about 1 mL to about 3 mL, such as about 1.15 mL. In any embodiment, the second volume may be about 55 mL to about 60 mL, such as about 59 mL. In any embodiment, the third volume may be about 195 mL to about 200 mL, such as about 197 mL.

### Functional Design Elements

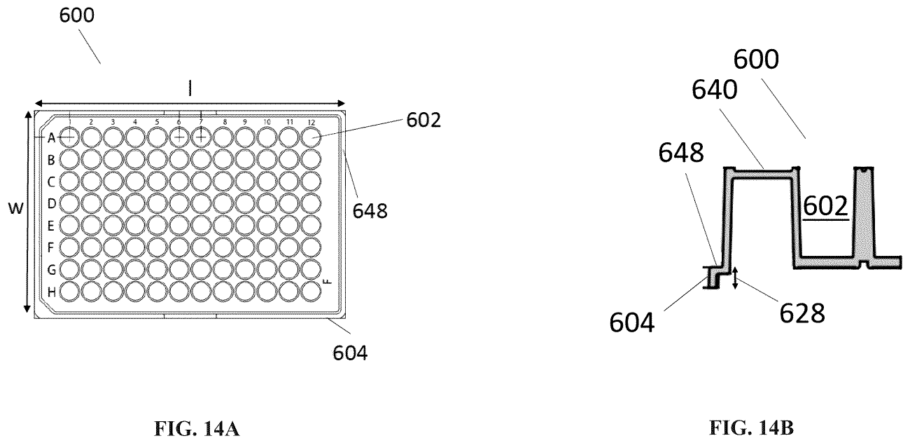

Advantageously, the various design elements of the reservoirs described above enable compatibility with laboratory equipment often used therewith, such as centrifuges, waste receptacles, well plates (e.g., 6-, 12-, 24-, 48-, 96-, 384-, or 1536-well microplates, including PCR microplates which may be non-skirted or skirted). For example, a liquid reservoir as described herein may be sized to allow nesting of an inverted well plate and/or PCR plate containing a liquid reagent in the liquid reservoir, such that the wells face the liquid space but are supported above the floor portion by the supporting projections. Therefore, the nesting distance, which is the distance between the top of a supporting projection and the top edge of the reservoir, may be dictated to correspond to a feature common to many well plates. A 96-well plate is shown in FIG. 14a, having 96 wells 602 and a flange 648, which can be better seen in FIG. 14b. FIG. 14b depicts a partial cross-sectional view where the edge 604 of the well plate 600 comprises a flange 648. Upon inversion of the well plate and insertion into the top of a liquid reservoir comprising at least one support projection on each wall, the flange 648 may rest on the top surface of each support projection to provide nesting of the well plate in the reservoir. As such, the nesting height 128, 228, 328 of the support projections 122, 130, 222, 230, 332, 330, as described in FIGS. 1-12, may correspond to a flange height 628 of a well plate to be used therewith. In any embodiment, a flange may be absent (e.g., non-skirted or semi-skirted PCR plate) or be about 0.1 mm to about 5 mm in height. Typically, flange heights on standardized well plates are 2 mm to 2.5 mm. In deep well plates, the flange height may range from 2.5 mm to 8 mm. Therefore, the nesting distance, in any embodiment, may be about 0.1 mm to about 5 mm, such as about 2.0 mm, about 2.5 mm, about 3 mm, about 4 mm, about 5 mm, about 6 mm, or approximately the size of a flange on a compatible well plate. In embodiments compatible with non-skirted or semi-skirted PCR plates, a supporting projection may be any size, simply serving to provide support to the overturned PCR plate nested within the reservoir. For example, in any embodiment where a flange is absent, an upper surface of a wall plate 650 may rest upon the support projections 122, 130, 222, 230, 332, 330, as described in FIGS. 1-12, preferably where the upper surface contacts the support projection at a location that does not overlap with any wells in the well plate.

The well-plate in FIG. 14a also is characterized by a length I and a width w, which may be any value compatible or suitable with a workflow or instrument in a laboratory. For example, well plates are typically about 100 mm to about 150 mm in length and about 70 mm to about 100 mm wide. Generally, the size of a well plate is standardized across manufacturers for compatibility across a wide variety of uses. For example, the length of well plates available from ThermoFisher and Grainger have a length of 127.76 mm and a width of 85.48 mm. For a snug fit, the inside length of the reservoir (dictated by the length of the first and third wall segments and subtracting the wall thickness therefrom) may be slightly smaller than the outside length of the well plate for a snug fit. For example, in any embodiment, the inside length of a reservoir, as described herein, may be about 0.5 to about 1.5 mm smaller than a compatible well plate, such as about 0.5 mm to about 1 mm, about 1 mm to about 1.5 mm, or about 0.75 mm to about 1.25 mm. The exact length will depend on the flexibility of the construction material of the reservoir, which will be discussed further below. For a well plate that is about 127 mm to about 128 mm long, a suitable inside length may be about 126 mm to about 128 mm. Likewise, the inside width of the reservoir (dictated by the length of the second and fourth wall segments and subtracting the wall thickness therefrom) may be slightly smaller than the outside width of the well plate for a snug fit. For example, in any embodiment, the inside width of a reservoir, as described herein, may be about 0.5 mm to about 1.5 mm smaller than a compatible well plate, such as about 0.5 mm to about 1 mm, about 1 mm to about 1.5 mm, or about 0.75 mm to about 1.25 mm. The exact width will depend on the flexibility of the construction material of the reservoir, which will be discussed further below. For a well plate that is about 85.5 mm long, a suitable inside length may be about 84 mm to about 85 mm, such as about 84.5 mm. A plurality of securing projections, if included and as described above, may further aid in providing a snug fit between the reservoir and an inverted well plate. As such, each securing projection may independently project from its corresponding wall at a distance of about 0.5 mm to about 1.5 mm.

The height of a liquid reservoir is not particularly limited in function, except in any respect related to compatibility with other laboratory instrumentation that will be used therewith. For example, many centrifuges are limited in the height of an object that may be safely contained therein.

In any embodiment, a voided bottom such as shown in FIGS. 1-12 reduces the amount of construction materials of the reservoir, but also enables compatibility and interoperability with various other devices common in the laboratory and designed to improve workflow, such as, but not limited to, reagent dispensers, liquid waste removers, and adaptors that enable thermal and mechanical motion control of the reservoir.

A liquid reservoir, as described herein, may be made of any material, and may be selected based on an intended use. For example, a liquid reservoir may be manufactured with materials that are resistant to degradation by water, solvents, and other frequently used reagents as well as high temperature (e.g., for sterilization) and have high mechanical strength (e.g., for use in a centrifuge). The surface that will contact the liquid (e.g., the surface of the floor portion and the inside surface of each of the first, second, third, and fourth wall segments, herein “inner surfaces”) may have properties that minimize loss of liquid and reagent. These properties may be ubiquitous to the construction material itself or may be imparted upon one or more inner surfaces alone. Such properties include, but are not limited to, hydrophobicity, hydrophilicity, low permeability, resistance to binding of biochemical molecules (e.g., proteins, peptides, DNA, RNA, and the like), resistance to leaching, resistance to oxidation, resistance to reduction, low surface area, chemical stability (e.g., low reactivity), resistance to irradiation, and resistance to physical force (such as resistance to etching).

For example, suitable construction materials include polypropylene (PP), polyethylene (e.g., HPDE, LPDE), polystyrene, polyether ether ketone (PEEK), polycarbonate, polyallomer, polyvinyl chloride (PVC), chlorinated polyvinyl chloride (CPVC), polytetrafluoroethylene (Teflon), polyvinylidene fluoride (PVDF), polyvinyl fluoride (PVF), polychlorotrifluoroethylene (PCTFE), perfluoroalkoxy alkane (PFA), fluorinated ethylene-propylene (FEP), polyethylenetetrafluoroethylene (ETFE), a fluoroelastomer (vinylidene fluoride-based, FPM/FKM), tetrafluoroethylene-propylene (FEPM), perfluoropolyether (PFPE), perfluorosulfonic acid (PFSA), perfluoropolyoxetane; polyethylene terephthalate G copolymer (PETG), polysulfone (PSF), polymers of cyclic olefins (including homopolymers and copolymers), acrylonitrile butadiene styrene (ABS), nylon (e.g., PA-6, PA-66, PA-12), poly(methyl methacrylate) (PMMA), or any blend or copolymer thereof. In any embodiment, the construction material may be particularly chemically resistant and temperature resistant from about −196° C. to about 120° C. for capability with extreme freezing (e.g., −80° C.) and autoclaving.

In any embodiment, one or more inner surfaces may exhibit properties that differ from the bulk material of the liquid reservoir, for example, through post-manufacture modification (e.g., physical or chemical modification) or the properties may be imparted in situ during manufacturing. For example, one or more inner surfaces may be treated or coated with a biologically inert material. For example, in any embodiment, one or more inner surfaces, e.g., of a PVDF-based liquid reservoir, may be coated or treated with a copolymer formed by zwitterionization of poly(styrene-r-4-vinylpyridine), zP(S-r-4VP). Other biologically inert coatings include, but are not limited to, silicon coatings, such as SILCONERT® (available from SilcoTek, Bellefonte, PA, USA), a carboxysilicon, such as DURSAN® coatings (also available from SilcoTek). In another example, one or more inner surfaces may be conjugated with antibodies for positive and negative selection-based sample preparation or with nucleic acids to serve as aptameric binding ligands or Watson-Crick base-pairing sequence specific binding ligand. In yet another example, one or more inner surfaces may be treated with a silane as a functional coating or with reagents suitable for use in Click Chemistry. In yet another example, one or more inner surfaces may be plasma treated for modification of water contact angle.

In yet another example, one or more of the inner surfaces may be polished to reduce the surface area arising from microporosity of the construction material. A high level of surface polish creates a surface that facilitates liquid beading and migration of any liquid beads to the low collection point of the reservoir, thereby minimizing reagent loss. Alternatively, one or more of the inner surfaces may be treated to impart a rough and therefore a higher surface area. Such treatment may be advantageous, for example, if the use of the liquid reservoir involves ligation of, e.g., a capture antibody.

Alternatively, or additionally, a liquid reservoir may be manufactured using surface modifying additives (SMAs), surface modifying macromolecules (SMMs), and/or surface modifying end groups (SMEs) to impart particularly desired properties to one or more inner surfaces of a liquid reservoir.

### Methods of Manufacture

The methods by which a liquid reservoir as described and disclosed herein may be manufactured are not particularly limited and generally may be constructed by processes commonly used in polymer manufacturing. For example, in any embodiment, a liquid reservoir, as described herein, may be made by additive fusion deposition molding (FDM), additive selective laser sintering (SLS), additive stereolithography (SLA), reductive manual machining, reductive computer numerically controlled (CNC) machining, injection molding, blow molding, and vacuum forming.

As discussed above, it may be desirable to impart one or more properties to one or more inner surfaces of a liquid reservoir that differ from the properties of the bulk construction material, which may be accomplished in situ during manufacturing through the use of various additives or post-manufacturing by modifying one or more inner surfaces of a liquid reservoir.

The type of post-manufacturing surface modifications that may be implemented are not particularly limited and are well known to those of skill in the art. For example, one or more inner surfaces of a liquid reservoir may be subject to plasma discharge to oxidize the surface of the polymer, leaving underlying bulk layers unchanged. Such a treatment may change the contact angle of the polymer, e.g., create a more hydrophilic surface. In another example, functional molecules may be immobilized (e.g., conjugated) to one or more inner surfaces of the liquid reservoir. Such functional molecules include, but are not limited to, nucleic acids (e.g., RNAs, DNA), peptides, proteins (e.g., heparin, hirudin, albumin), antibodies, and the like. Other exemplary processes include, but are not limited to, ultraviolet irradiation, ion implantation, polishing, impregnation, etching, grafting, photo-lithography, or coating (e.g., a polymeric coating that differs from the primary construction material of the reservoir). One of skill in the art will be familiar with and be able to employ appropriate methods for such surface modifications.

Alternatively, or additionally, one or more surface modifying additives (SMAs), surface modifying macromolecules (SMMs), and/or surface modifying end groups (SMEs) may be incorporated during manufacturing to impart particularly desired properties to one or more surfaces of a liquid reservoir. SMMs are based on the use of an amphiphilic tri-block copolymer formed by a hydrophobic or hydrophilic segment, usually identical or compatible with the polymeric matrix, and end-capping block segments (silicones, fluorinated segments, olefins, and others) with low polarity, of which perfluorinated segments have been among the most commonly used. SMAs are amphiphilic di-block or tri-block copolymers where one of the blocks has higher affinity for the bulk material and the other block has little attraction for the base polymer, usually due to lower polarity or higher hydrophilicity. SMEs are not considered additives, but are part of the base polymer backbone itself.

### Methods of Use

The liquid reservoirs may be used in any application where liquid retention is desired with additional advantages gained in automated applications where reagent recovery is important. Examples of reagents that may be collected in the liquid reservoirs described and disclosed herein are not particularly limited, but include, as non-limiting examples only, proteins, peptides, nucleic acids, nucleotides, spent cell culture media, prepared reagents, chemical intermediates, and the like.

For example, a liquid reservoir, as described herein may be used in next generation sequencing (NGS). After amplification by PCR, a well plate (typically a 384-well plate) can be inverted into a liquid reservoir as described herein and centrifuged to dispel all material from the well plate into the reservoir. Reagent can then be recovered from the liquid reservoir with little to no waste, particularly in embodiments with a single low point, for further processing. Advantageously, the liquid reservoirs may also be compatible with other laboratory equipment, such as the ClickBio® Bottomless Waste Station (available from ClickBio®, Reno, NV, USA) as well as other products available from ClickBio®.

### Fluid Provision Module

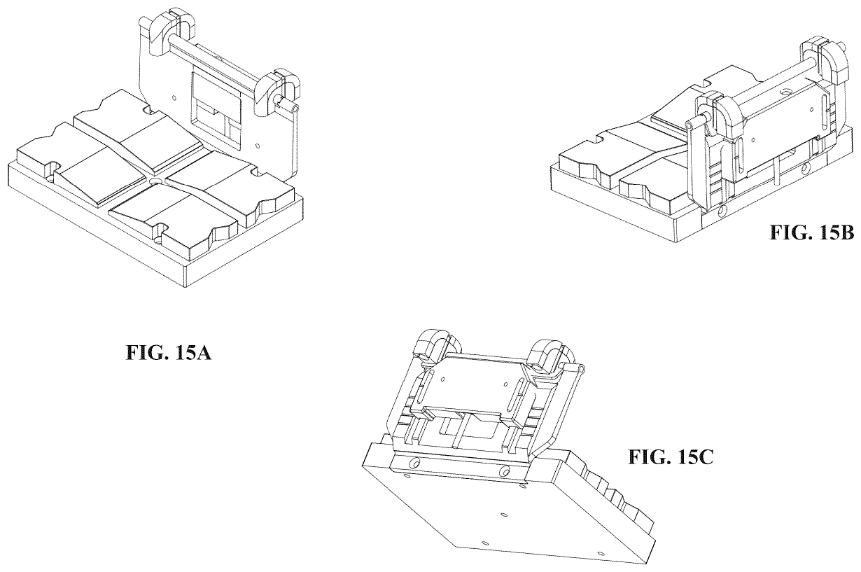

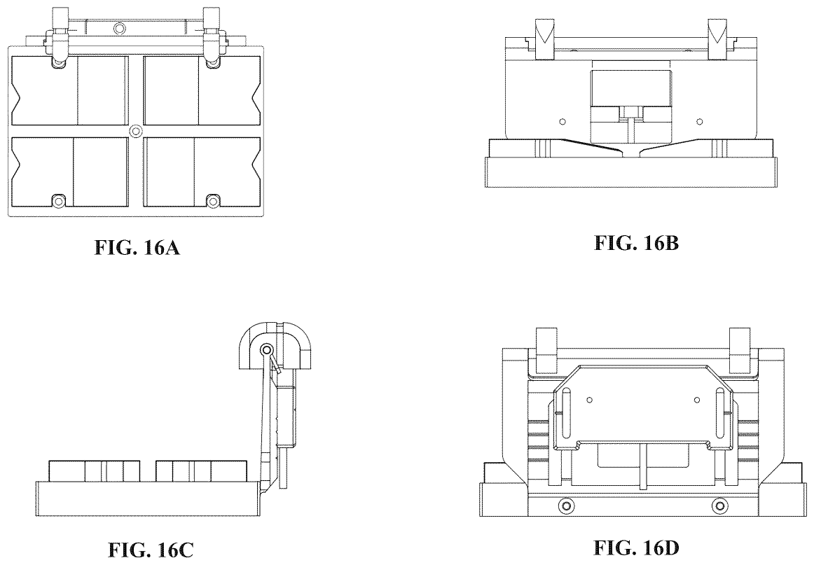

Also disclosed herein is a fluid provision module 700 for collecting and preserving valuable fluids. The fluid provision module comprises a fluid supply tube 702 for providing fluid, a fluid drain tube 703 for removing fluid, a pump 800 for pumping fluid, and a sensor 704 for sensing fluid level. The fluid supply tube and the fluid drain tube are adjustable, such that they may be positioned in differing configurations depending on the needs of a user of the module. For example, the fluid supply tube and the fluid drain tube may be positioned to accommodate either a single-channel pipette or a multichannel pipette with minimal loss of fluid. Multiple views of the module in one of its configurations are shown in FIG. 15 and FIG. 16.

Each component of the module that is intended to come in contact with a fluid may be composed of materials that may be disposed of or sterilized between uses. This prevents contamination and allows the user to easily prepare the module for a new fluid without risk of impurities from previous uses of the module.

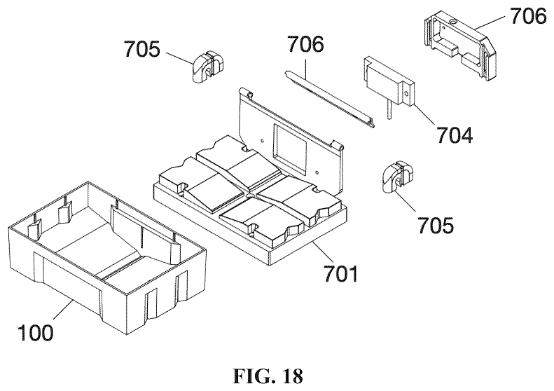

Further components of the fluid provision module are shown in FIG. 18 and may comprise a base 701, a tubing clip rail mount 705, a rail hinge 706, and a sensor mount 707.

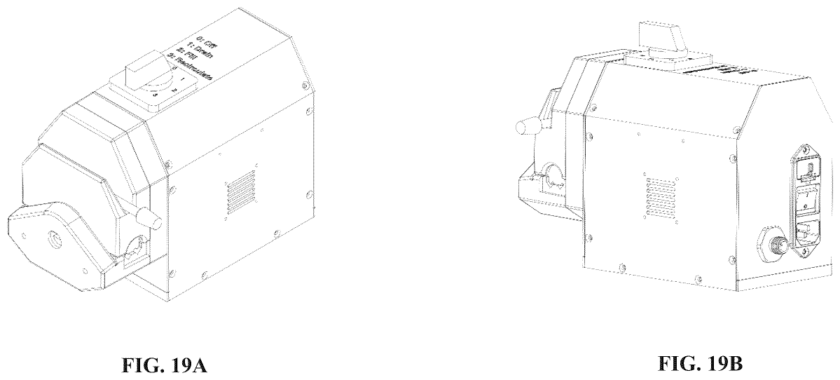

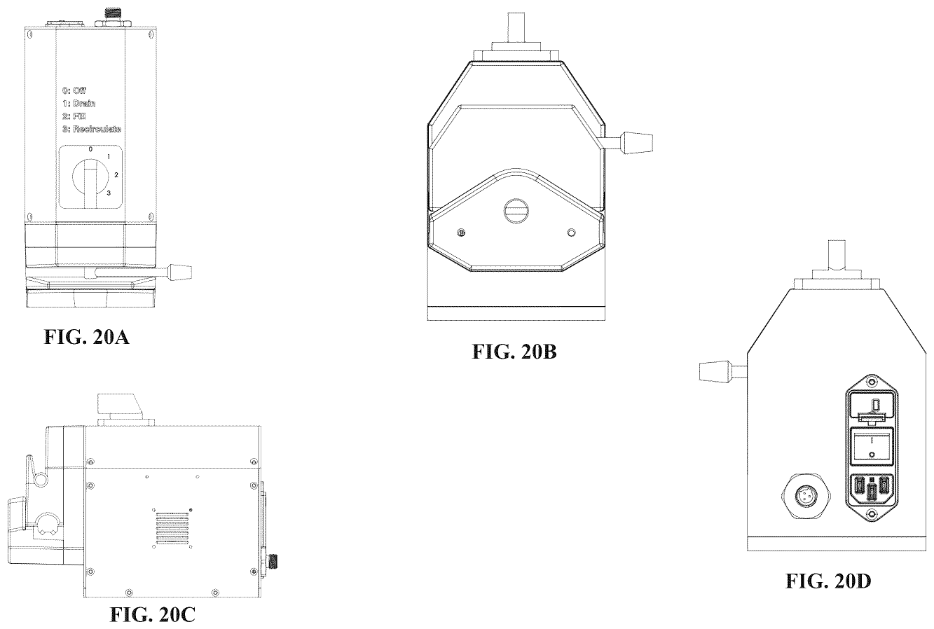

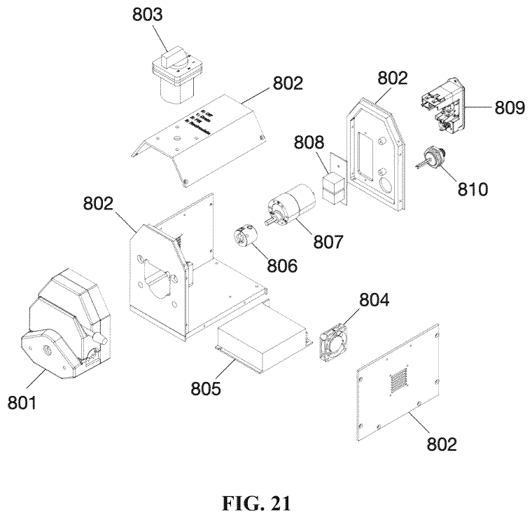

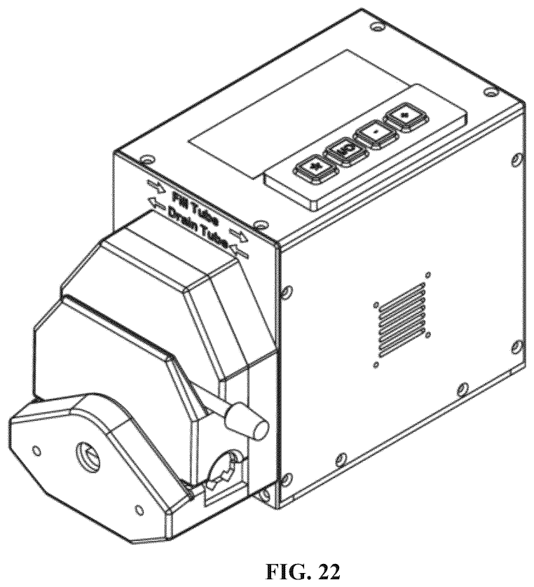

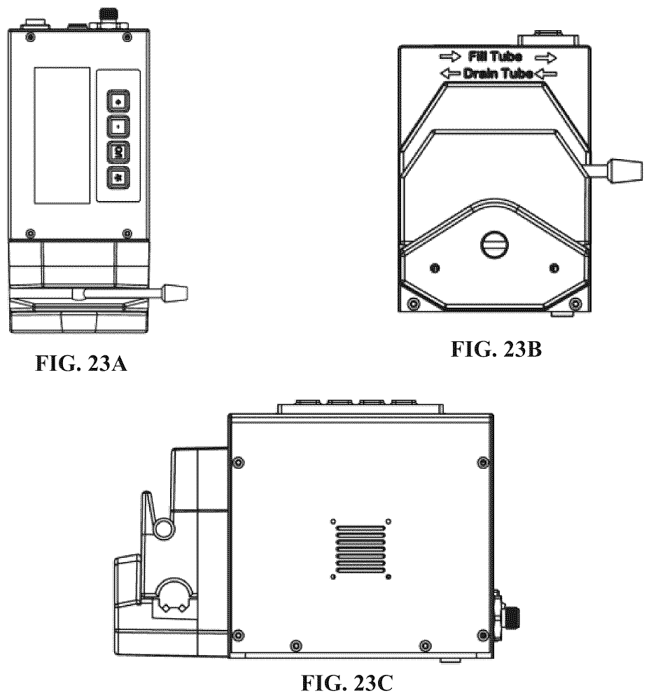

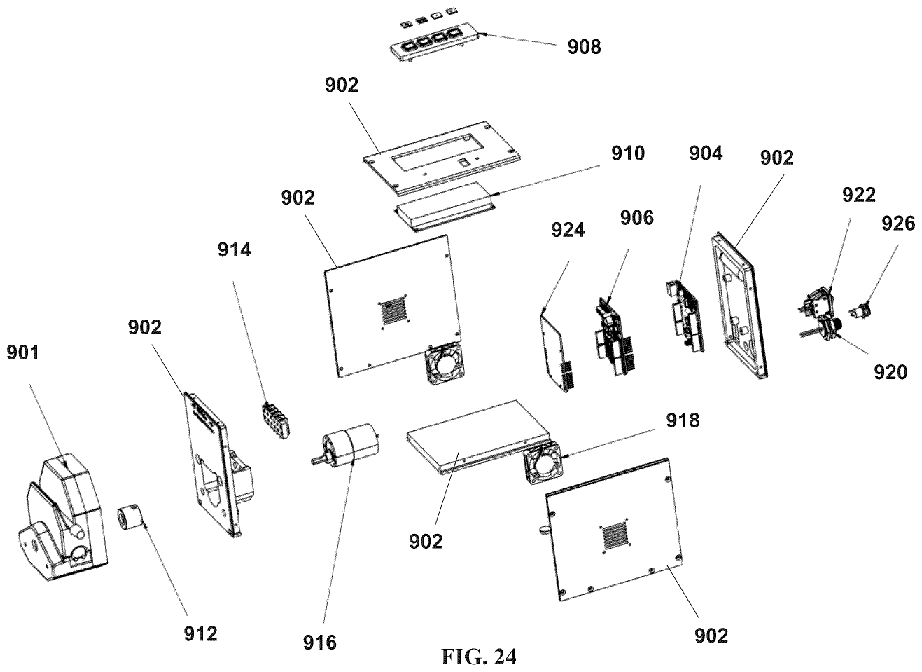

The pump is used to pump fluid through the fluid supply tube and/or the fluid drain tube. The pump may be any of a positive displacement pump, a centrifugal pump, a peristaltic pump, or an axial-flow pump. The pump may be controlled by the sensor, a timer, or a combination of the sensor and a timer. In some embodiments, the pump may be controlled by a microcontroller, or an external liquid handling robot. Multiple views of an exemplary pump are shown in FIGS. 19A-19B and FIGS. 20A-20D. Components of the exemplary pump from FIGS. 19A-19B and 20A-20D are shown in FIG. 21 and may comprise a pump head 801, a pump housing 802, a rotary switch 803, a cooling fan 804, a power supply 805, a motor coupling 806, a brushed DC motor 807, a control circuit PCB 808, a power entry module 809, and a sensor cable pass through 810. Multiple views of another exemplary pump are shown in FIGS. 22 and FIGS. 23A-23C. Components of the exemplary pump from FIGS. 22 and FIGS. 23A-23C are shown in FIG. 24 and may comprise a pump head 901, a pump housing 902, a microcontroller 904 (e.g., Arduino™), a motor controller 906 (e.g., with pulse width modulation), a keypad 908, a screen 910 (e.g., an LCD screen), a motor coupling 912, a circuit terminal block 914 (e.g., a four circuit terminal block), a gearmotor 916, a cooling fan 918, a sensor cable pass through 920, a power switch 922, a connector board 924, and a barrel jack connector 926. The motor controller 906 may include a PWM motor controller board wherein a user may change the speed of the pump motor.

The sensor can be used to sense fluid level. The sensor may be any of an optical sensor, a vibrating sensor, an ultrasonic sensor, a capacitance sensor, a radar sensor, or a conductivity sensor. The module may be designed such that, if the sensor detects that the fluid level is above a certain point, the pump shuts off and fluid ceases to be pumped through the fluid supply tube. The module may be designed such that, if the sensor detects that the fluid level is below a certain point, the pump turns on and fluid is pumped through the fluid supply tube.

The fluid drain tube may be used as an overflow prevention mechanism, so that in the case of imminent overflow, the fluid will instead flow through the fluid drain tube to be collected in a designated collection vessel. For example, if the sensor fails and the module continues filling beyond the specified point, the fluid drain tube allows the fluid to be collected safely without risk of overflow and subsequent loss of fluid.

The speed at which liquid is pumped through the fluid supply tube and the fluid drain tube may be variable and adjusted by the user. The module may also include a timeout feature, wherein a user may set an amount of time after which the pump is turned off. In some embodiments, the timeout feature may be used to turn off the pump if a tube breaks and/or when the source bottle runs empty. These features serve as both an overflow prevention method and a power saving method, to prevent the pump from continuing to run indefinitely in the case of a sensor failure, as well as a method of preventing undue wear on the motor and tubing.

The module is compatible with liquid handling robots, allowing for the straightforward integration with existing laboratory setups and the convenience of automated use. When used with external liquid handling robots, the module may not require software integration.

The module may be configured such that both fluid tubes function as drain tubes, allowing the module to function as a fluid waste station.

The module may be configured as a continuously recirculating fill station, wherein the fluid supply tube and fluid drain tube are positioned at the same height within the module, such that the filling and refilling cycle is continuous. The module may be configured to have agitation and drain modes. An agitation mode may periodically reverse the motor, allowing the motor to drain a small amount of liquid, and then refill until the sensor indicates the reservoir is full. Similar to the recirculation mode, this provides a pulse of liquid to help provide agitation. A drain mode may be configured to reverse the motor and drain the reservoir back into the source bottle.

The orientations of the fluid provision module components described herein are not intended to be limiting, and it will be obvious to those skilled in the art that the adjustability of the components may yield a configuration not explicitly described herein. This adjustability is one of the many advantages of the present invention and any alternative configurations are within the scope of this disclosure.

### Use of Fluid Provision Module in Combination with Reservoir

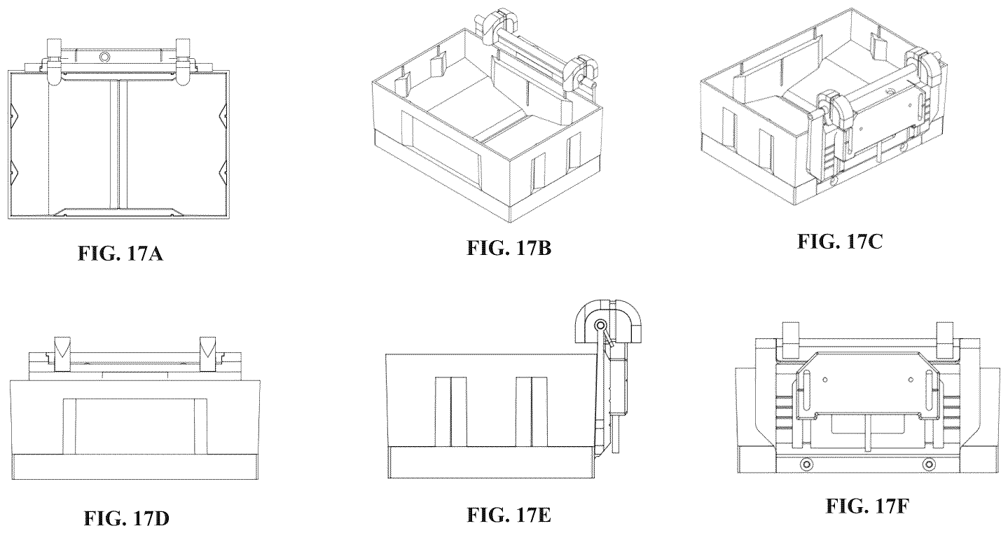

The fluid provision module may be used in combination with the reservoir. The fluid provision module may be attached to the side of the reservoir, through clipping, fastening, or other attachment methods, such that the fluid provision module may be used with the reservoir. FIG. 17 shows multiple views of the system when combined, and FIG. 18 shows an exploded view of the system with its main component.

When the fluid provision module and reservoir are used together as a system, the system may be designed such that the sensor senses the fluid level within reservoir. The system may be configured such that, if the sensor detects that the fluid level in the reservoir is below a certain point, the pump is turned on and fluid is pumped through the fluid supply tube into the reservoir. The system may be designed such that, if the sensor detects that the fluid level is above a certain point, the pump shuts off and fluid ceases to be pumped through the fluid supply tube into the reservoir. For example, the sensor may be set so that the reservoir is filled to a percentage of its total fluid capacity, such as 10% to 80%, or 20% to 70%, or 30% to 50%. The speed at which the reservoir is filled or emptied may be variable and adjusted by the user.

The fluid provision module and reservoir system may be composed of materials that may be disposed of or sterilized between uses, preventing contamination. Each component of the system that comes in contact with a fluid may be easily replaced or sterilized.

The fluid provision module and reservoir system may include a timeout feature, wherein a user may set an amount of time after which the pump is turned off. This serves as both an overflow prevention method and a power saving method, to prevent the pump from continuing to run indefinitely in the case of a sensor failure.

The fluid drain tube may be used as an overflow prevention mechanism, so that in the case of imminent overflow of the reservoir, the fluid will instead flow through the fluid drain tube to be collected in a designated collection vessel. For example, if the sensor fails and the module continues filling beyond the specified point, the fluid drain tube allows the fluid to be collected safely without risk of overflow and subsequent loss of fluid from the reservoir.

The system may be configured such that that both fluid tubes function as drain tubes, allowing the module to function as a fluid waste station.

The system may be configured as a continuously recirculating fill station, wherein the fluid supply tube and fluid drain tube are positioned at the same height within the module, such that the filling and refilling cycle is continuous.

1. A fluid provision module, comprising:
a fluid supply tube for providing fluid,
a fluid drain tube for removing fluid,
a pump for pumping fluid, and
a sensor for determining fluid level.

2. The fluid provision module of claim 1, wherein the fluid supply tube is adjustable.

3. The fluid provision module of claim 1, wherein the fluid drain tube is adjustable.

4. The fluid provision module of claim 1, wherein the pump is any of a positive displacement pump, a centrifugal pump, or an axial-flow pump.

5. The fluid provision module of claim 1, wherein the pump is a peristaltic pump.

6. The fluid provision module of claim 1, wherein the sensor is any of an optical sensor, a vibrating sensor, an ultrasonic sensor, a capacitance sensor, a radar sensor, or a conductivity sensor.

7. A system for minimizing the loss of fluids, comprising a fluid provision module having:
a fluid supply tube for providing fluid,
a fluid drain tube for removing fluid,
a pump for pumping fluid, and
a sensor for determining fluid level,
and further comprising a fluid reservoir for containing fluid.

8. The system of claim 7, wherein the fluid provision module is attached to the fluid reservoir.

9. The system of claim 7, wherein the fluid supply tube is adjustable.

10. The system of claim 7, wherein the fluid drain tube is adjustable.

11. The system of claim 7, wherein the pump is any of a positive displacement pump, a centrifugal pump, or an axial-flow pump.

12. The system of claim 7, wherein the pump is a peristaltic pump.

13. The system of claim 7, wherein the sensor is any of an optical sensor, a vibrating sensor, an ultrasonic sensor, a capacitance sensor, a radar sensor, or a conductivity sensor.
